(19) United States
(12) Patent Application Publication
(10) Pub. No.: US 2016/0078032 A1
(43) Pub. Date: Mar. 17, 2016

(54) METHOD OF ON-LINE MEDIA SCORING

(71) Applicant: Yangbin Wang, Palo Alto, CA (US)

(72) Inventor: Yangbin Wang, Palo Alto, CA (US)

(21) Appl. No.: 14/485,969

(22) Filed: Sep. 15, 2014

(51) Int. Cl. G06F 17/30

(52) U.S. Cl. CPC G06F 17/30038; G06F 17/30867; G06F 17/30663

(57) ABSTRACT

The present invention relates to a method of on-line media scoring technique comprising calculating view share, clip match duration percentage and website balance to generate on-line media score for the media and to determine popularity of the media across different Internet sites.

### BACKGROUND OF THE INVENTION

1. Field of the Invention

The present invention relates to a method of on-line media scoring technique comprising calculating view share, clip match duration percentage and website balance to generate on-line media score for the media and to determine popularity of the media across different Internet sites.

2. Description of the Related Art

The on-line media scoring technique has been evolving quickly among researchers, engineers and scientists because it is very important for on-line content delivery, content display, content sharing and content management.

In Derso et al's 2006 Physics Review E paper titled “dynamics of information access on the web” (Physical Review E 73, 066132, 2006), the authors investigated the dynamics of visitation of a major news portal, representing the prototype for a rapidly evolving network. The authors found that the visitation pattern of a news document decays as a power law, in contrast with the exponential prediction provided by simple models of site visitation. The authors argued that this is rooted in the inhomogeneous nature of the browsing pattern characterizing individual users: the time interval between consecutive visits by the same user to the site follows a power-law distribution, in contrast to the exponential expected for Poisson processes.

In Barabasl's 2005 Nature paper titled “the origin of bursts and heavy tails in human dynamics” (Vol 435, pp. 207-211, Nature 2005), the author showed that the timing of many human activities follow non-Possion statistics, characterized by bursts of rapidly occurring events separated by long periods of inactivity. The author further showed that this bursty nature of human behavior is a consequence of a decision-based queuing process: when individuals execute tasks based on some perceived priority, the timing of the tasks will be heavy tailed, with most tasks being rapidly executed, whereas a few experience very long waiting times. In contrast, random or priority blind execution is well approximated by uniform inter-event statistics.

In Broxton et al's 2011 J Intell Inf Syst paper titled “catching a viral video” (J Intell Inf Syst, DOI 10.1007/s10844-011-0191-2, 2011), the authors analyzed sharing and its relationship to video popularity using millions of YouTube videos to better understand viral videos on YouTube. The socialness of a video is quantified by classifying the referrer sources for video views as social (e.g. an emailed link, Facebook referral) or non-social (e.g. a link from related videos). The authors found that viewership patterns of highly social videos are very different from less social videos. For example, the highly social videos rise to, and fall from, their peak popularity more quickly than less social videos. The authors also found that not all highly social videos become popular, and not all popular videos are highly social. By using the insights on viral videos, the authors were able develop a method for ranking blogs and websites on their ability to spread viral videos.

In Borghol et al's 2011 Elsevier paper titled “characterizing and modeling popularity of user-generated videos” (Volume 68, Issue 11, pp. 1037-1055, Elsevier, 2011), the authors developed a framework for studying the popularity dynamics of user-generated videos, presented a characterization of the popularity dynamics, and proposed a model that captures the key properties of these dynamics. Using a dataset that tracks the views to a sample of recently uploaded YouTube videos over the first eight months of their lifetime, the authors studied the popularity dynamics and found that the relative popularities of the videos within their dataset were highly non-stationary, owing primarily to large differences in the required time since upload until peak popularity is finally achieved, and secondly to popularity oscillation. The authors proposed a model that can accurately capture the popularity dynamics of collections of recently-uploaded videos as they age, including key measures such as hot set churn statistics, and the evolution of the viewing rate and total views distributions over time.

In Figueiredo's 2013 paper presented at the sixth ACM international conference on Web Search and Data Mining (WSDM) titled “on the prediction of popularity of trends and hits for user generated videos” (Proc. of the 6th ACM int'l conf. on Web search and data mining, pp. 741-746, 2013), the author studied YouTube videos to understand and predict popularity trends (e.g, will a video be viral?) and hits (e.g, how may views will a video receive?) of user generated videos. The author summarized the latest findings in this paper regarding (1) uncovering common popularity trends; (2) measuring associations between UGC features and popularity trends; and (3) assessing the effectiveness of models for predicting popularity trends.

In Yang et al's 2011 paper presented at the sixth ACM international conference on Web Search and Data Mining (WSDM) titled “patterns of temporal variation in online media” (Proc. of the 4th ACM int'l conf. on Web search and data mining, pp. 177-186, 2011), the authors studied temporal patterns associated with online content and how the content's popularity grows and fades over time. The authors formulated a time series-clustering problem using a similarity metric that is invariant to scaling and shifting in order to uncover the temporal dynamics of online textual content and developed the K-Spectral Centroid (K-SC) clustering algorithm that effectively finds cluster centroids with their similarity measure. The authors demonstrated their approach on two massive datasets: a set of 580 million Tweets, and a set of 170 million blog posts and news media articles. The authors found that K-SC outperforms the K-means clustering algorithm in finding distinct shapes of time series, and their analysis showed that there are six main temporal shapes of attention of online content. The authors also presented a simple model that reliably predicts the shape of attention by using information about only a small number of participants. Their analyses offered insight into common temporal patterns of the textual content on the Web and broaden the under-standing of the dynamics of human attention.

In Szabo's 2010 paper published in Communications of the ACM titled “predicting the popularity of online content” (vol. 53, no. 8, pp. 80-88, Communications of the ACM, 2010), the authors examined two very popular content-sharing portals—Digg and YouTube in order to predict the long-term popularity of online content based on early measurements of user access. The authors demonstrated that by modeling the accrual of votes on and views of content offered by these services they were able to predict the dynamics of individual submissions from initial data. In Digg, measuring access to given stories during the first two hours after posting allowed the authors to forecast their popularity 30 days ahead with a remarkable relative error of 10%, while downloads of YouTube videos had to be followed for 10 days to achieve the same relative error. The differing time scales of the predictions are due to differences in how content is consumed on the two portals; Digg stories quickly become outdated, while YouTube videos are still found long after they are submitted to the portal. Predictions are therefore more accurate for submissions for which attention fades quickly, whereas predictions for content with a longer life cycle are prone to larger statistical error. The authors also performed experiments showing that once content is exposed to a wide audience, the social network provided by the service does not affect which users will tend to look at the content, and social networks are thus not effective promoting downloads on a large scale. However, they are important in the stages when content exposure is con-strained to a small number of users.

In Gursun et al's 2011 IEEE InfoCom conference paper titled “describing and forecasting video access patterns” (INFOCOM, 2011 Proceedings by IEEE, pp. 16-20, 2011), the authors analyzed an extensive dataset consisting of the daily access counts of hundreds of thousands of YouTube videos in order to assist in the design and provisioning of computer systems that are driven by workloads that reflect large-scale social behavior, such as rapid changes in the popularity of media items like videos. The authors found that there are two types of videos: those that show rapid changes in popularity (rarely-accessed videos), and those that are consistently popular over long time periods (frequently-accessed videos). The authors developed two different frameworks for characterization and forecasting of access patterns, and showed that for frequently-accessed videos, daily access patterns can be extracted via principal component analysis, and used efficiently for forecasting. For rarely accessed videos, the authors demonstrated a clustering method that allows one to classify bursts of popularity and use those classifications for forecasting.

In Crane et al's 2008 PNAS paper titled “robust dynamic classes revealed by measuring the response function of a social system” (vol. 105, no. 41, pp. 15649-15653, PNAS 2008), the authors studied the relaxation response of a social system after endogenous and exogenous bursts of activity using the time series of daily views for nearly 5 million videos on YouTube and found that most activity can be described accurately as a Poisson process. However, the authors also found hundreds of thousands of examples in which a burst of activity is followed by a ubiquitous power-law relaxation governing the timing of views. The authors found that these relaxation exponents cluster into three distinct classes and allow for the classification of collective human dynamics. This is consistent with an epidemic model on a social network containing two ingredients: a power-law distribution of waiting times between cause and action and an epidemic cascade of actions becoming the cause of future actions.

This model is a conceptual extension of the fluctuation-dissipation theorem to social systems, and provides a unique framework for the investigation of timing in complex systems.

In Figueiredo et al's 2011 paper published in Communications of the ACM titled “The tube over time: characterizing popularity growth of YouTube videos” (Proc. of the 4th ACM int'l conf. on Web search and data mining, pp. 745-754, 2011), the authors analyzed how the popularity of individual videos evolves since the video's upload time.

The authors' analyses were performed separately for three video datasets, namely, videos that appear in the YouTube top lists, videos removed from the system due to copyright violation, and videos selected according to random queries submitted to YouTube's search engine. The results showed that popularity growth patterns depend on the video dataset. In particular, copyright protected videos tend to get most of their views much earlier in their lifetimes, often exhibiting a popularity growth characterized by a viral epidemic-like propagation process. In contrast, videos in the top lists tend to experience sudden significant bursts of popularity. The authors also showed that not only search but also other YouTube internal mechanisms play important roles to attract users to videos in all three datasets.

### SUMMARY OF THE INVENTION

An object of the present invention is to overcome at least some of the drawbacks relating to the prior arts as mentioned above.

The fundamental idea of the Vobile Score (V-Score) is to give a measure of the online presence of a media with an emphasis on its current and past performance. A media is a piece of content, such as a movie, a TV show episode, a music, etc. A clip is a copy of a media uploaded to a website. Our invention focuses on the performance of media—that is, the aggregate performance of all the clips of a media. Analyzing media rather than individual clips is made possible by the data of the present invention crawling the entire internet. To the best of our knowledge, no one has ever done before.

Based on the unique data of the present invention, we advance the state of the art of research on the behavior of online media to determine that different clips are from the same media, observe the behavior of a media by observing the aggregate behavior of its clips, compare the performance of the same media on multiple websites, tell how much of a media a clip includes and where in the media the clip begins, and identify clips from media as components of mashups.

A media's online score should take account of its current performance and past performance. The performance of a media is based on the number of views it has received, the number of clips created from it, and the number of websites its clips appear on and the characteristics of these websites. The distribution of the score can change over time. The score can comprise multiple sub-scores, and should ignore the effects of suppression.

### Vobile Score (V-Score) Components

A media's V-Score comprises three components: the view share, the clip match-duration percentage and the website balance.

### The View Share

One measure of a media's online presence is its current view counts. But rather than report the raw view counts, we instead report the media's share of the global view counts. That is, on a given day, what fraction of all viewing activity was of our given media? This normalization effectively endows the metrics with a sense of continuity over large time scales. It is reasonable to expect that present day viewing activity is different from ten years ago. So, without any normalization, and assuming that global media viewing activity has increased in the last decade, scores today would be perpetually inflated, and it would be difficult to get a sense of how today's scores compare with scores from an earlier era. We may also calculate a media's view rate on a per-website basis, so that we may give a site a lower weight if we feel the data from that site is too idiosyncratic.

### The Clip Match-Duration Percentage

Some portion of each clip matches some portion of a media. We assert that a media has better online presence if most views are of clips with high match percentage.

Conversely, if most of a media's views are of clips with a low match percentage, this denotes a comparatively weaker online presence.

### The Website Balance

A media can be judged by how evenly its view rate is distributed across all websites. A media whose views are concentrated at a small number of sites scores lower than a media whose views occupy an equal share across all sites. A formula that captures our intuitive notion of “equal distribution” is given by Jain's Fairness index F. The “fairness” of the distribution of video x across all n websites is given by the formula:

$${S}_{wb} ( x ( t ) ) = F ( x ( t ) ) = \frac{{( {Σ}_{i} {x}_{i} ( t ) )}^{2}}{n {Σ}_{i} {{x}_{i} ( t )}^{2}} ,$$

where x(t)=(x₁(t), x₂(t), . . . , xₙ(t)) denote the media's view rate as a percentage of the total view rate on each of n websites. This score ranges from 1/n to 1. When the view rate percentages are roughly equal across all websites, S_{wb} is close to 1. When the view rate percentages are highly skewed toward one site, S_{wb} is close to 1/n. A nice feature of this formula is that it is scale invariant, so that a media with a relatively low view rate is just as likely to have a high score as a media with a relatively high view rate.

### V-Score of Online Media

The sub-scores of view share, the clip match-duration percentage, and website balance all range between 0 and 1, but they have different distributions with time. We sum a media's z-scores of the three sub-scores and derive a media's V-Score. Although we do not normalize in order to guarantee an invariant distribution of scores over time, the Law of Large Numbers will ensure this invariance, for sufficiently large samples. A benefit of having a time-invariant distribution is that a given score will retain its intuitive meaning from one year to the next.

### Time Evolution of View Share

The temporal evolution of a media's view share can reveal significant amount of information regarding to the view pattern of the media and how the media got popular. A key requirement for this finding is to prepare the data set of the time series of the view share. Since a clip's cumulative view is read sporadically, not more than once per day.

We first use linear interpolation to estimate a single clip's daily view share between any two observations. The raw data is sometimes very noisy. We use a moving average to smooth out the interpolated daily view share.

A clip's cumulative view is read sporadically in the database system, not more than once per day, giving an increasing sequence
(u(t₀), . . . , u(t_{f}))
   where tᵢ is the integer number of days since the clip's post date. Given view share data for the collection of clips C (e.g., clips that match a given media, or clips that are posted to a given website), we wish to form a time series x(t) that gives the collection's aggregate daily view rate on consecutive days. Since our raw data is sometimes noisy, we will additionally smooth out u(t) using a moving average.

First, we use linear interpolation to estimate a single clip's daily view count between any two observations:

$$v ( t ) = \{ \begin{matrix}\frac{u ( {t}_{i + 1} ) - u ( {t}_{i} )}{{t}_{i + 1} - {t}_{i}} & for {t}_{i} < t \leq {t}_{i + 1} \\ 0 & otherwise\end{matrix}$$

Next, we sum these interpolated daily view count time series across all clips in the collection C to obtain the view share for the media:

$$w ( t ) = {\sum }_{v ∈ C} v ( t )$$

As an example, C could be the set of all clips matching a given media, in which case w(t) is the video's daily view share.

Finally, we replace the aggregated time series w(t) by its exponential moving average, to smooth it out a bit. This is defined recursively as:

x(t)=aw(t)+(1−a)x(t−1)

for some fixed 0<a<1. When a is close to 1, the derived series responds slowly to current data and therefore is very smooth. When a if close to 0, x(t) resembles the underlying time series w(t).

In many cases time series of view share exhibit distinct shapes. The shape can provide information about what caused a clip to become popular, and about features of the clip and the relevant social network. We discovered that there are three aspects of the shape of the temporal evolution of the view counts.

First, increases in popularity take different forms. Increases caused by external events are exogenous and exhibit a sharp spike preceded by few or no views. Increases caused by word-of-mouth are endogenous and exhibit a gradual build up of views.

Second, a pattern is critical when the viewing of a clip by some members of a social network is likely to lead to the clip's being viewed by other members of the network. A pattern that is not critical is subcritical.

Third, the persistence metric distinguishes cases where a clip receives most of its views at its peak of popularity from cases where views are more evenly distributed over the life span of the clip.

There are many cases in which there is a single, well-defined peak that falls clearly into one of the categories described. But there are also many compound and hybrid cases, with multiple peaks and combinations of exogenous and endogenous bursts. A key point to note is that despite the variability in the features of the temporal evolution of views, such as the number of peaks and their shape, the temporal patterns tend to be made up of a small number of primitive elements.

Similarly we can obtain the time evolution of a media's clip match duration percentage, website balance, and the media's V-Score.

There are many possible applications for the time evolution of a media's V-Score and subscores. With multiple sub-scores, we can get at different aspects of medias that will be useful for different purposes such as predicting a media's performance, i.e., whether it is about to go viral, developing a virality indicator to guide placement of contextual advertising, using web balancing score to help with movie rollout strategy across countries, adjusting a media's advertising campaign, identifying effective suppression strategies, and providing measures of the popularity of the media's protagonists.

Characteristics of Websites where Medias are Posted

The websites where medias are posted are a potentially interesting feature in understanding the media's internet behavior qualitatively. Some of them are restricted to specific regions by languages, others require subscriptions, others specialize. Here we look at the websites only in the context of the dataset of the present invention, without using any external information.

Clustering website data produces some interesting results. The first approach is to use Hierarchical Clustering. Hierarchical clustering of the Divisive type iteratively splits a data set on two subsets such that the two subsets have the largest dissimilarity. This type of clustering creates a binary tree of sub-clusters. As long as the data points are relatively few, this produces a great visualization.

The numerical features that we have chosen are these:
a) Number of Media posts
b) Number of Media views
c) Duration of Media Clip
d) Total number of copyright take-down notices sent

The objective of the last feature is to help gain some understanding into the relative copyright compliance of the various websites.

The features are scaled to zero mean and unit variance and the Euclidean distance in R4 is used as a dissimilarity metric. The results of the hierarchical clustering are grouped into five bigger clusters. Note that youtube and vkontakte are alone in their own clusters.

To gain some more insight into the structure of the clusters, we perform K-means clustering with five clusters, and plot the results against the two principal components of the data. We discovered that youtube and vkontakte not only stand apart from everything else but are also very far apart from each other. This is mainly due to the very high number of copyright take-down notices sent to vkontakte vs. youtube.

All these and other introductions of the present invention will become much clear when the drawings as well as the detailed descriptions are taken into consideration

### BRIEF DESCRIPTION OF THE DRAWINGS

For the full understanding of the nature of the present invention, reference should be made to the following detailed descriptions with the accompanying drawings in which:

FIG. 1 illustrates the three components to describe a media's internet presence: view share, clip match duration percentage (CMDP), and website balance, and the methodologies to construct a media's V-Score to describe its popularity before the entire internet users.

FIG. 2 illustrates the method to determine the form of popularity of a media by constructing the time evolution of a media's view share before the entire internet users and analyzing the distinctive shapes of the temporal evolution in terms of exogenous and endogenous growth of its view share, critical pattern and subcritical pattern of its view share, and the level of persistence of its view share.

FIG. 3 illustrate the method to cluster the internet sites which hosts or distributes a media with numerical characteristics of the sites.

Like reference numerals refer to like parts throughout the several views of the drawings.

### DESCRIPTION OF THE PREFERRED EMBODIMENT

The present invention now will be described more fully hereinafter with reference to the accompanying drawings, in which some examples of the embodiments of the present inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

A media means the original content supplied by a client in the present invention; a clip means a partial copy of the media that is posted on the internet.

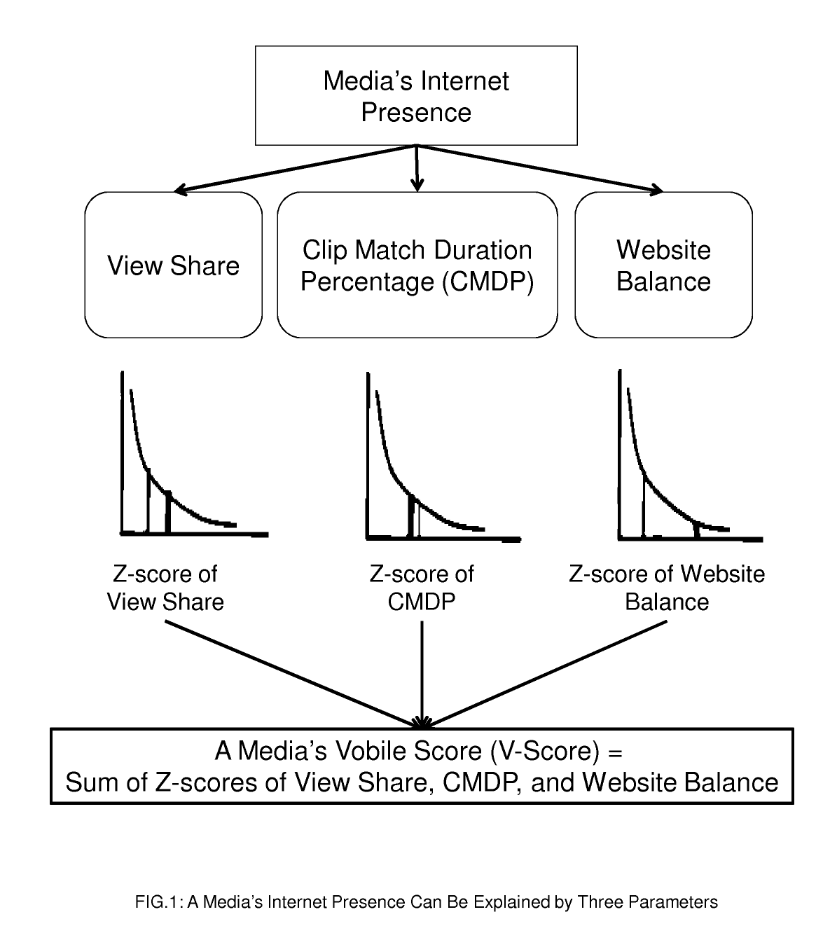

FIG. 1 describes that a media's internet presence can be described by three components: the view share of the media by aggregating all clips belonging to this media throughout the internet, the match duration percentage for each clip relative to the original media, and the website balance of all the clips. Furthermore, the V-Score of a media is constructed by the combination of the three components: the view share, the clip match duration percentage, and the website balance.

### View Share

A media's view share describes that on a given day, what the fraction of all media viewing activity was of our given media. In its most basic form, the view rate score of a video x at time t is given by

$${S}_{vs} ( x , t ) = \frac{x ( t )}{{Σ}_{y ∈ all media} y ( t )}$$

The above formula considers all website to be equal. However we may also calculate this score on a per-website basis, so that we may give a site a lower weight if the data from that site is too idiosyncratic.

Given a sequence of weights w=(w₁, w₂, . . . , wₙ) such that sum(wᵢ)=1, a weighted view rate score takes the form

$${S}_{vs} ( x , w , t ) = {\sum }_{i} {w}_{i} \frac{{x}_{i} ( t )}{{Σ}_{i} {y}_{i} ( t )} ,$$

where xᵢ(t) denotes the view rate of media x restricted to site i. When we choose weights

$${w}_{i} = \frac{{Σ}_{i} {y}_{i} ( t )}{{Σ}_{y ∈ all videos} y ( t )} ,$$

we recover our original formula Sᵥₛ(x,t).

A media's view share Sᵥₛ may take any value between 0 and 1, and the sum of the view share of all medias should be equal to 1.

### Clip Match Duration Percentage

For each of the clip that we identify as a match of an original media, either the entire clip or a portion of the clip matches the entire media or a portion of the media. The unique dataset of the present invention crawling the clips over the entire Internet allows us to analyze the matched clip length relative to the original media. For two medias with the same view rate for their clips on the internet, we assert that the media whose clips have higher match duration percentage has better online presence.

Let C be the set of clips matching a given media x, and let |•| denote time duration of a clip. The match duration percentage score is defined as

$${S}_{m p} ( x , t ) = \frac{{Σ}_{v ∈ C} v ( t ) \vert v \vert}{x ( t ) \vert x \vert}$$

For example, if a media has six clips on the internet and each clip has one view. There are four clips that only match 20% of the original media, one clip that matches 40% of the original media, and one clip that matches 90% of the original media. The match duration percentage score is:

(1*0.2+1*0.2+1*0.2+1*0.2+1*0.4+1*0.9)/(6*1)=0.35

The match duration percentage score ranges from 0 to 1.

### Website Balance

The views of a media can all come from a single website (such as Youtube in the United States or Youku from China), or evenly distribute among all website across the globe.

This information (website balance) gives indications about the popularity of the media among different demographic population since different website will likely have audience with different demographics. Similarly, the same website accessed in desktop or in mobile platform also has different audience demographics.

We define that a media whose views are concentrated at a small number of sites scores lower than a media whose views occupy an equal share across all sites.

For a given media x, let x(t)=(x₁(t), x₂(t), . . . , xₙ(t)) denote the media's view rate as a percentage of the total view rate on each of n websites. The website balance score of the distribution across all n website is given by Jain's Fairness Index F

$${S}_{wb} ( x ( t ) ) = F ( x ( t ) ) = \frac{{( {Σ}_{i} {x}_{i} ( t ) )}^{2}}{n {Σ}_{i} {{x}_{i} ( t )}^{2}} ,$$

For example, we have two medias with clips spreading over six different websites. For media 1, its view shares on these six websites are 50%, 60%, 80%, 60%, 70%, and 40%, respectively. While for media 2, its view shares on these six websites are all 20%. The website balance score for media 1 is 0.96, and the website balance score for media 2 is 1. At present, media 2's views have a more consistent share of each website.

We see that the website balance score ranges from 1/n to 1. When the view rate percentages are roughly equal across all websites, the website balance score is close to 1. When the view rate percentages are highly skewed toward one site, the website balance score approaches 1/n.

We also notice that a media's website balance score is scale invariant, so that a media with a relatively low view rate is just as likely to have a high score as a media with a relatively high view rate.

### A Media's V-Score

With a media's view share, clip match duration percentage, and website balance, we can construct the V-Score of a media. A media's V-Score is a combination of the sub-scores of view share, clip match duration percentage (CMDP), and website balance.

The three sub-scores are random variables ranging between 0 and 1 and have different distributions. To capture the statistics behavior of the sub-scores, we use a z-score to describe the statistical impact of a given media's presence in a given day relative to its statistical distribution. A z-score is the signed number of standard deviations a statistical variable is above its mean. For a normal distribution, the z-score is between −1 and 1 with 68% of confidence, the z-score is between −2 and 2 with 95% of confidence, and the z-score is between −3 and 3 with 99.7% of confidence.

We sum a media's z-scores of view share, clip match duration percentage, and website balance, and obtain the media's V-Score. If a media's z-score of view share is 1, z-score of clip match duration percentage is −0.5, and z-score of website balance is 2, we obtain the media's V-Score to be 2.5. Although we do not normalize in order to guarantee an invariant distribution of scores over time, the Law of Large Numbers will probably ensure this invariance, for sufficiently large samples. A benefit of having a time-invariant distribution is that a given score will retain its intuitive meaning from one year to the next.

There are many possible applications for the V-Score and sub-scores. With multiple sub-scores, we can get at different aspects of a media that will be useful for different purposes. For example, we can predict a media's performance such as whether it is about to go viral. We can develop a virality indicator to guide placement of contextual advertising. We can use web balance score to help with media rollout strategy across countries. We can adjust a media's advertising campaign. We can identify effective suppression strategies. And we can provide measures of the popularity of protagonists.

There are also a number of exciting possibilities for future work regarding to V-Score. For example, we can correlate scores with phenomena of interest to studios, such as movie revenue. We can augment feature set with other attributes of view count evolution in the literature. We can apply techniques in the literature for modeling and predicting time series of views. We can consider additional features of clips such as referrers, number of likes, and genre. And we can apply similar analyses to patterns of clips uploads.

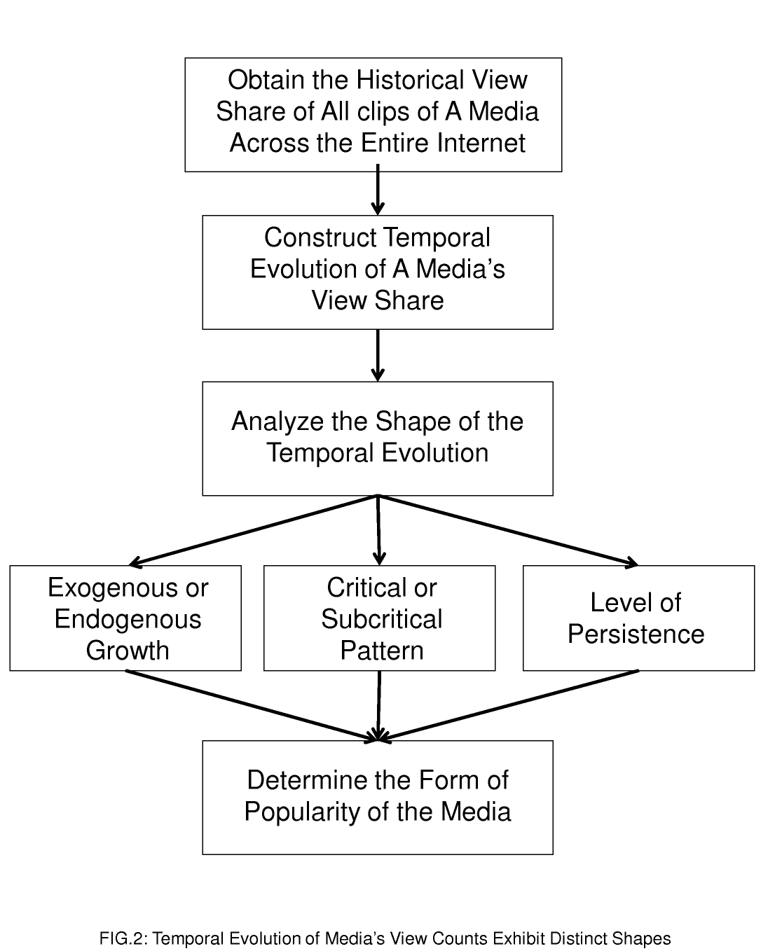

FIG. 2 describes the methodology to analyze the temporal evolution of view counts of a media exhibits and determine the form of popularity of the media from the distinctive shape of the temporal evolution. Since the datasets of the present invention contain the clip views of a media across the entire internet, we can discover unique information about what caused a clip to become popular, and about features of the clip and the relevant social network through the examination of the temporal evolution of view counts.

Based on the historical view share of a media from the database of the present invention crawled over the entire internet, we need to construct the daily temporal evolution of the media's view share. The daily temporal evolution of the media's view share is obtained from the following process: removing the noise of the datasets, interpolating the view share to estimate the daily view share for each clip of the media, summing the daily view share of all clips weighted by the characteristics of specific sites to obtain the view share of the media, and smoothing the media's view share to obtain the daily temporal evolution of the media's view share.

The distinctive shape of the temporal evolution of a media's view share reveals significant information regarding to how the media achieves popularity and the trends for the media. We analyze the shape of the temporal evolution of a media to identify three characteristics.

Exogenous Vs. Endogenous Growth of a Media

Exogenous growth describes a media's growth that is caused by external events and the temporal evolution of the media's view counts exhibits a sharp spike preceded by few or no views. For example, the view counts of Amy Winehouse music video exhibited a sharp spike around August of 2011. Tracing back the external events around Amy Winehouse, we discovered that Amy died of alcohol poisoning on Jul. 23, 2011.

Endogenous growth describes the phenomenon that a media's growth is caused by word-of-mouth and thus the video's view counts exhibit a gradual build up of views. For example, since the release in July 2012, the music video Gangnam style exhibited a gradual growth in view counts until it reached the first peak around October 2012. This can be explained by the viral effect of the media on Youtube and other social networks.

Critical Vs. Subcritical Pattern of a Media

For some clips, the viewing of a clip by some members of a social network is likely to lead to the clip's being viewed by other members of the network; while for other clips, the viewing of a clip has no correlation among the social network. A pattern is critical when the viewing of a clip by some members of a social network leads to the clip's being viewed by other members of the network. A temporal pattern that is not critical is subcritical. The temporal shape for a critical temporal pattern is smoother than that for a subcritical temporal pattern. For example, the music video Gangnam style gained popularity mostly due to word-of-mouth and thus the view counts of the media exhibited relatively smooth trails. On the contrary, the user-generated video “Jayden and Jacob's birthday party” was viewed mostly due to external stimulations within specific groups and thus the view counts exhibited sharp spikes along the timeline.

High Level Vs. Low Level of Persistence of a Media

A media's level of persistance describes the time span of the view counts of a media. A media has low level of persistence if it receives most of its views at its peak of popularity, and a media has high level of persistence if its views are more evenly distributed over the lifespan of the clip. For example, the short clip for Katharine Hepburn's academy awards appearance had a sharp spike in its view count during the academy awards time period, while Michael Jackson Pepsi Generation video has consistent view counts ever since the video first posted on the internet.

Although there are many cases in which there is a single, well-defined peak that falls clearly into one of the three categories described above, there are also many compound and hybrid cases with multiple peaks and combinations of exogenous and endogenous bursts. For example, the video Danny Bagwell Flips Violently At Daytona 1999 Live exhibited multiple spikes in the temporal evolution of its view counts. The spikes around February 2012 and February 2013 are exogenous bursts caused by external events, while the spike around July 2012 is endogenous burst. Similarly, the decays around February 2012 and February 2013 are subcritical decay, while the decay around July 2012 is critical decay.

A key point to note is that despite the variability in the features of the temporal evolution of views, such as the number of peaks and their shape, the temporal patterns tend to be made up of a small number of primitive elements such as exogenous burst and endogenous burst, critical decay and subcritical decay.

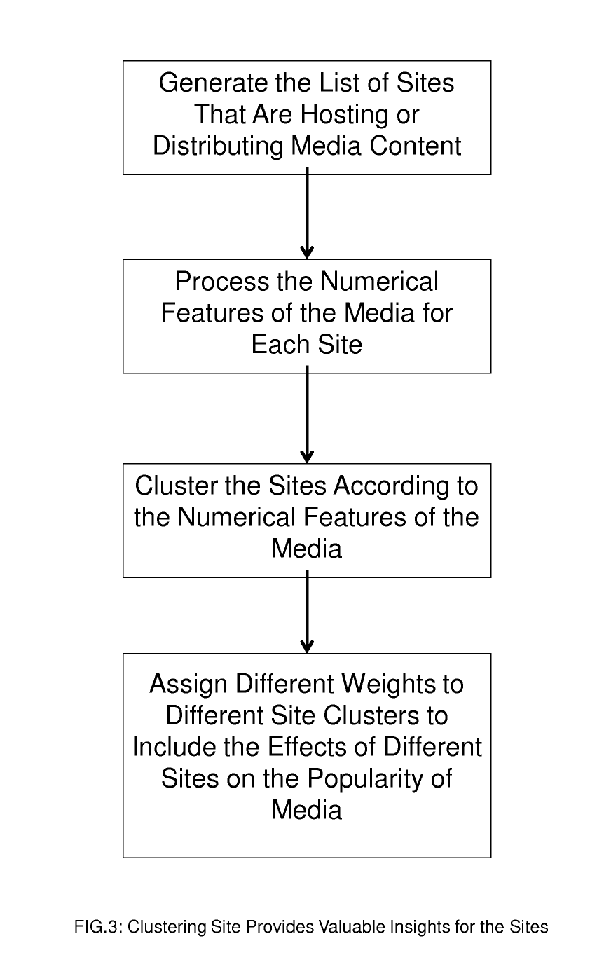

FIG. 3 describes the methodology to cluster the website of the present invention where medias are hosted or distributed. Different sites exhibit distinctive characteristics and their audience have different demographic. Understanding quantitatively and qualitatively of the numerical features of the website allow us to insert different weights to include the impact of the sites when determining the popularity of a media.

The numerical feature we can use to classify a site can include the following
a) Type of media
b) Number of media posts
c) Number of media views
d) Duration of media clip
e) Total number of copyright take-down notices sent

The objective of the last feature to include the total number of copyright take-down notices sent is to help gain some understanding into the relative copyright compliance of the various websites. We can also include the demographics or behavior information from the site's audience if available.

Through hierarchical clustering of the websites according to the numerical features assigned, the websites are grouped into several bigger clusters, where the sites in each of the cluster contain similar quality. We can also identify singularities among all the websites that exhibit distinctive feature from all other sites. For example, among the websites clustering of the present invention, YouTube and vkontakte are alone in their own clusters due to their superior popularity. To gain more insight into the structure of the clusters, we can perform K-means clustering with these clusters, and plot the results against the two principal components of the data. We observe that YouTube and vkontakte not only stand apart from everything else but are also very far apart from each other. This is mainly due to the very high number of notices sent to vkontakte vs. YouTube.

In summary, the present invention covers the following disclosures:

A method of on-line media scoring comprising:
a) processing and calculating view share of a media before entire Internet users,
b) processing and calculating clip match duration percentage (CMDP) relative to original media,
c) processing and calculating website balance of the view share to determine popularity of the media across different Internet sites, and
d) generating on-line media score by combining z-scores of the view share, the CMDP and the website balance.

The view share includes shares for utilization of video, audio and image of the media before the entire Internet users.

The entire Internet users include users across all Internet connected devices and platforms.

The processing view share can be done on a global basis to give equal weights to all the Internet sites, or can be done on a per-site basis to take into account different characteristics of the Internet sites.

The clip includes clips of video, audio, and image of the original media, and the CMDP describes portion of the clips propagating across the Internet relative to length of the original media.

The clips of video, audio, and image of same video can be given different weights to calculate the CMDP of the media.

The website balance describes how evenly its view rate is distributed before all the Internet users.

The website balance is calculated with formula of Jain's Fairness index to determine fairness of all the Internet sites in terms of the view share.

The website balance ranges from 1/n (worst case) to 1 (best case), wherein n is total number of the Internet sites.

The z-scores is signed number of standard deviation that a statistical variable is above its mean value, and the z-scores describes statistical behavior of the view share, the CMDP and the website balance of the media.

The online media score takes into account the view share, the CMDP and the website balance when describing popularity of the media.

The online media score generates a single number to describe the popularity of the media before the entire Internet users.

A method to process and analyze form of popularity of a media for on-line media scoring comprising:
a) processing temporal evolution of view share of the media before entire Internet users,
b) analyzing exogenous growth pattern or endogenous growth pattern of the temporal evolution of the view share,
c) analyzing critical growth pattern or subcritical growth pattern of the temporal evolution of the view share, and
d) analyzing level of persistence of the temporal evolution of the view share.

The temporal evolution of the view share describes statistical behavior of the view share with time.

The exogenous growth pattern describes view share growth caused by external events and the temporal evolution of the view share exhibits a sharp spike preceded by few or no views, while the endogenous growth pattern describes view share growth caused by word-of-mouth and the temporal evolution of the view share exhibits a gradual build-up of views.

The critical growth pattern describes viewing of the media by some members of a social network that is likely to lead to the media's being viewed by other members of the social network, while the subcritical growth pattern describes viewing of the media that is uncorrelated within the social network.

Low level metric of the level of persistence describes the media receiving most of its views at its peak of popularity, while high level metric of the level of persistence describes the view share of the media evenly distributed over life span of the media.

The temporal evolution of the view share provides information about what causes the media to become popular and can be used for different purposes including predicting the media's future performance, adjusting marketing campaign related to the media.

A method to characterize Internet sites where a media is posted or shown for on-line media scoring, the method comprising:
a) clustering the Internet sites according to a chosen set of numerical features,
b) grouping different sets of clusters that have similar features, and
c) assigning different weights to different groups to take into account characteristics of the Internet sites when describing popularity of the media.

The numerical features include number of the media posted, number of media views, duration of the media and total number of copyright infringement notices sent.

The aforementioned on-line media scoring method can be extended to on-line media ranking, on-line media grading and on-line media sorting, etc.

The method and system of the present invention are not meant to be limited to the aforementioned experiment, and the subsequent specific description utilization and explanation of certain characteristics previously recited as being characteristics of this experiment are not intended to be limited to such techniques.

Many modifications and other embodiments of the present invention set forth herein will come to mind to one ordinary skilled in the art to which the present invention pertains having the benefit of the teachings presented in the foregoing descriptions. Therefore, it is to be understood that the present invention is not to be limited to the specific examples of the embodiments disclosed and that modifications, variations, changes and other embodiments are intended to be included within the scope of the appended claims. Although specific terms are employed herein, they are used in a generic and descriptive sense only and not for purposes of limitation.

What is claimed:

1. A method of on-line media scoring comprising:
a) processing view share of a media before entire Internet users,
b) processing clip match duration percentage (CMDP) relative to original media,
c) processing website balance of said view share to determine popularity of said media across different Internet sites, and
d) generating on-line media score by combining z-scores of said view share, said CMDP and said website balance.

2. The method as recited in claim 1, wherein said view share includes shares for utilization of video, audio and image of said media before said entire Internet users.

3. The method as recited in claim 1, wherein said entire Internet users include users across all Internet connected devices and platforms.

4. The method as recited in claim 1, wherein said processing view share can be done on a global basis to give equal weights to all said Internet sites, or can be done on a per-site basis to take into account different characteristics of said Internet sites.

5. The method as recited in claim 1, wherein said clip includes clips of video, audio, and image of said original media, and said CMDP describes portion of said clips propagating across the Internet relative to length of said original media.

6. The method as recited in claim 5, wherein said clips of video, audio, and image of same video can be given different weights to calculate said CMDP of said media.

7. The method as recited in claim 1, wherein said website balance describes how evenly its view rate is distributed before all said Internet users.

8. The method as recited in claim 1, wherein said website balance is calculated with formula of Jain's Fairness index to determine fairness of all said Internet sites in terms of said view share.

9. The method as recited in claim 1, wherein said website balance ranges from 1/n (worst case) to 1 (best case), wherein n is total number of said Internet sites.

10. The method as recited in claim 1, wherein said z-scores is signed number of standard deviation that a statistical variable is above its mean value, and said z-scores describes statistical behavior of said view share, said CMDP and said website balance of said media.

11. The method as recited in claim 1, wherein said online media score takes into account said view share, said CMDP and said website balance when describing popularity of said media.

12. The method as recited in claim 1, wherein said online media score generates a single number to describe said popularity of said media before said entire Internet users.

13. A method to process and analyze form of popularity of a media for on-line media scoring comprising:
a) processing temporal evolution of view share of said media before entire Internet users,
b) analyzing exogenous growth pattern or endogenous growth pattern of said temporal evolution of said view share,
c) analyzing critical growth pattern or subcritical growth pattern of said temporal evolution of said view share, and
d) analyzing level of persistence of said temporal evolution of said view share.

14. The method as recited in claim 13, wherein said temporal evolution of said view share describes statistical behavior of said view share with time.

15. The method as recited in claim 13, wherein said exogenous growth pattern describes view share growth caused by external events and said temporal evolution of said view share exhibits a sharp spike preceded by few or no views, while said endogenous growth pattern describes view share growth caused by word-of-mouth and said temporal evolution of said view share exhibits a gradual build-up of views.

16. The method as recited in claim 13, wherein said critical growth pattern describes viewing of said media by some members of a social network that is likely to lead to said media's being viewed by other members of said social network, while said subcritical growth pattern describes viewing of said media that is uncorrelated within said social network.

17. The method as recited in claim 13, wherein low level metric of said level of persistence describes said media receiving most of its views at its peak of popularity, while high level metric of said level of persistence describes said view share of said media evenly distributed over life span of said media.

18. The method as recited in claim 13, wherein said temporal evolution of said view share provides information about what causes said media to become popular and can be used for different purposes including predicting said media's future performance, adjusting marketing campaign related to said media.

19. A method to characterize Internet sites where a media is posted or shown for on-line media scoring, said method comprising:
a) clustering said Internet sites according to a chosen set of numerical features,
b) grouping different sets of clusters that have similar features, and
c) assigning different weights to different groups to take into account characteristics of said Internet sites when describing popularity of said media.

20. The method as recited in claim 19, wherein said numerical features include number of said media posted, number of media views, duration of said media and total number of copyright infringement notices sent.
